(19) United States
(12) Patent Application Publication
(10) Pub. No.: US 2008/0040527 A1
(43) Pub. Date: Feb. 14, 2008

(54) Management module

(76) Inventors: Metodi N. Filipov, West Islip, NY (US); Naim R. Malik, Somerset, NJ (US); William J. Klingler, Colts Neck, NJ (US)

Correspondence Address: GIBBONS P.C., ONE GATEWAY CENTER, NEWARK, NJ, 07102, US

(21) Appl. No.: 11/503,632

(22) Filed: Aug. 14, 2006

(51) Int. Cl. G06F 13/00

(52) U.S. Cl. 710/303

(57) ABSTRACT

A management module that provides remote access and control of a computing device includes a keyboard, video and mouse (KVM) switch, a KVM over Internet Protocol (KVMoIP) module, and an Ethernet switch. It may also include a serial module and/or a microprocessor. The management module may be embedded in a circuit board such as a motherboard, daughterboard, baseboard or equivalent structure, of desktops, servers, notebooks, docking stations, personal digital assistants, and next generation phones or implemented as a dongle for connection to any of such devices. The management module provides out of band access by IT personnel and permits such persons to get full control of such equipped devices. Utilization of the modules enhances security, permits off peak hour maintenance, reduces downtime, and requires no end user involvement.

### FIELD OF THE INVENTION

The invention relates to a technique that provides remote access to a computing device that is independent of the operating system or operational state of such computing device. The computing device may be a notebook, handheld or desktop computer, or a personal digital assistant (“PDA”) or a cellular, wireless or wired telephone. The technique utilizes a module that is embedded in a circuit board in the computing device or located in an ancillary device, e.g., a docking station, that is connected to the computing device or via a dongle. More specifically, the module may include a keyboard, video, mouse (KVM) switch, a microprocessor, a KVM over Internet Protocol device (KVMoIP), an Ethernet hub/switch, and a serial switch and may be embedded in a baseboard, motherboard, daughter-board, or provided as an external device.

### BACKGROUND OF THE INVENTION

The nature of present mobile computers, such as notebooks and PDAs, prevents information technology (“IT”) personnel from readily having access to control such computers, other than through tools that are dependent upon the operating system used by such computers being operational and, therefore, such devices being in an “on” state. At times, the computing device requiring remote access has operating system difficulties or the device has been turned off and there is nobody at the device to turn it back on. It would therefore be desirable to provide a solution that enables IT administrators, and help desk personnel, to have the ability to remotely access to and control computing devices computers without the above-described limitations.

The above limitations in remote access capability is shown in FIG. 1. Referring to FIG. 1, a conventional baseboard of a “breakout box” or a notebook computer docking station is shown that can not be remotely accessed by IT personnel, other than through tools that require a properly functioning operating system. A “breakout box” is apparatus in which the signal connections for a compound electrical connector are separated or “broken out” into their component connectors. Compound connectors are generally proprietary to the supplier of the docking station, and are used where sufficient space for (or access to) connections is unavailable. There are connection ports for VGA, PS/2, USB, ETH (Ethernet), Serial and Power.

### BRIEF SUMMARY OF THE INVENTION

A management module according to the principles of the invention module includes a keyboard, video and mouse (KVM) switch, a KVM over Internet Protocol (KVMoIP) module, and an Ethernet switch. It may also include a serial module and/or a microprocessor.

The management module may be embedded in a circuit board, such as a motherboard, daughterboard, baseboard or equivalent structure, of a desktop, server, notebook computer, PDA or cellular, wireless or wired telephone. The module may also be implemented in an ancillary device, including a docking station or dongle, for connection to any of such devices. The management module provides IT personnel with full remote access and control of such equipped devices independent of the state of the equipped device. Utilization of the modules enhances security, permits off peak hour maintenance, reduces downtime, and requires no end user involvement.

### BRIEF DESCRIPTION OF THE DRAWINGS

In the drawings:

FIG. 1 is a schematic diagram of a conventional docking station for a notebook computer.

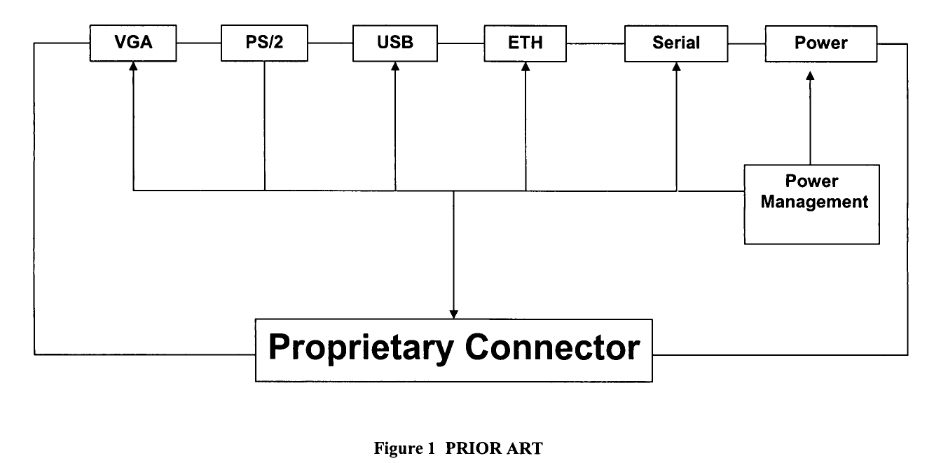

FIG. 2 is a schematic diagram of a module in accordance with a one embodiment of the invention.

FIG. 3 is a schematic diagram of another module in accordance with a another embodiment of the invention.

FIG. 4 is a schematic diagram of a system architecture in which a network of workstations are accessible by IT personnel or administrators via the Internet, the workstations including baseboards embedded with a module of any of the embodiments shown in FIGS. 2 and 3.

### DETAILED DESCRIPTION OF THE INVENTION

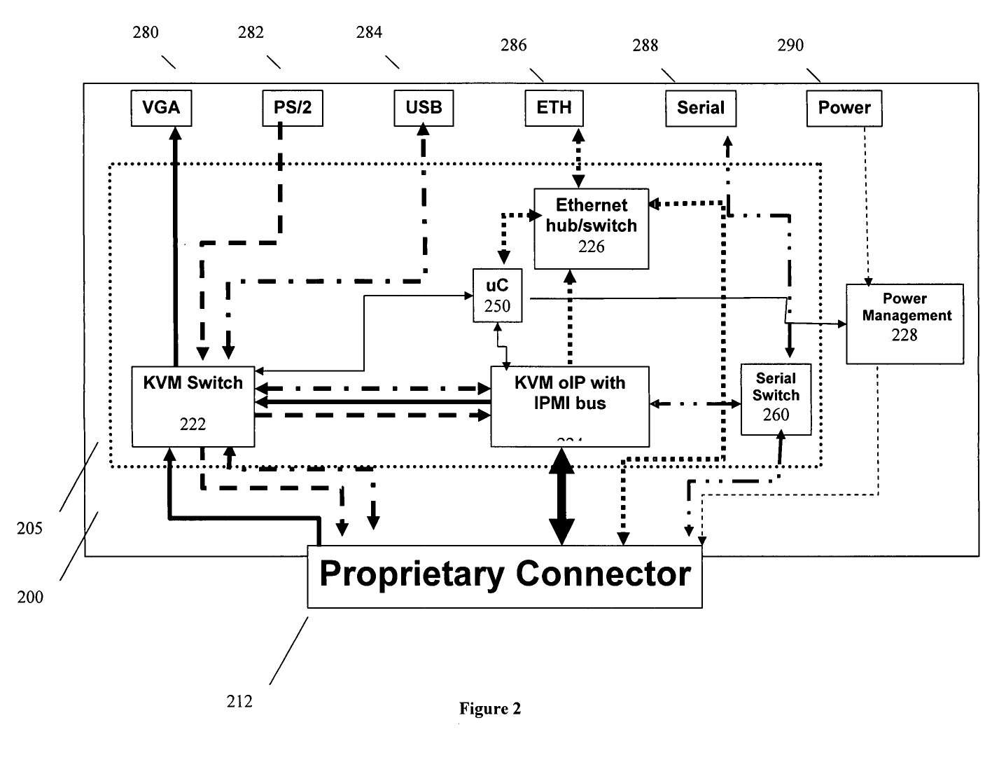

Referring now to FIG. 2, in accordance with one embodiment of the invention, a docking station 200 is equipped with an illustrative module 205 that can operated on demand in a normal/conventional mode or in a maintenance mode. In the latter mode, the notebook computer connected to the docking station can be remotely accessed and maintained. In the normal/conventional mode, module 205 permits local keyboard, video (monitor) and mouse signals to be conventionally communicated to the notebook computer user. When remote access is desired, the module redirects these signals to IT personnel that are remote from the docking station. An indicator light or software alert (neither shown) may be used to indicate that the docking station or notebook computer is in the maintenance mode.

As shown in FIG. 2, docking station 200 includes a module 205. Docking station 200 includes a proprietary connector 212 for coupling with the notebook computer and connector ports 280, 282, 284, 286, 288 and 290 for respectively coupling video (denoted as “VGA” and could be any representative video graphic adaptor), PS/2, Universal Serial Bus (USB), Ethernet (or any other local area network (LAN) topology), Serial and Power signals. Power management module 228 is connected to power 290 and connector 212. Although the exemplary embodiment shown is a docking station, the inventive management module can be implemented in a baseboard, daughterboard, motherboard or any equivalent board.

More particularly, module 205 includes a keyboard, video, mouse (“KVM”) switch (KVM switch) 222, a keyboard, video, mouse over Internet Protocol module (KVMoIP module) 224, an Ethernet hub/switch 226, a microprocessor (“μP”) 250 and a serial switch 260. KVMoIP 224 can include an Intelligent Platform Management Interface (IPMI) bus which permits certain system diagnosis even if a device or system is not powered or active. Ethernet hub/switch 226 can be any of a number of LAN topologies and accompanying switches. Microprocessor 250 may be compliant with standards for open platform management architecture (OPMA) and/or IPMI. Module 205, as well as the other embodiments illustrated below, can be used to create ASICs for implementation into any number of devices.

KVM switch 222 is connected to VGA port 280, PS/2 port 282, USB port 284, connector 212 and KVMoIP module 224. KVMoIP module 224 is further connected to Ethernet hub/switch 226, connector 212, and μP 250, which is, in turn, connected to Ethernet hub/switch 226 and power management 228. Moreover, serial switch 260 is connected to serial port 288 and connector 212.

In accordance with the principles of the invention, a docking station equipped with module 205, for example, would operate in a normal/conventional mode or in a maintenance mode wherein the notebook computer could be remotely accessed and maintained. Module 205 permits local keyboard, video (monitor) and mouse signals to be used in a conventional mode and when remote access is required, keyboard, video and mouse signals are redirected to via a remote management system to IT personnel.

More specifically, in normal operation, KVM switch 222 in module 205 will connect video, keyboard and mouse (KVM) signals between the notebook computer, via specific connector 212, and connectors 280, 282, 284, 286, 288 and 290.

When remote access is required, a remote workstation or computer will establish a connection with μP 250 utilizing standard Ethernet media and TCP/IP protocols via Ethernet/hub switch 226 and ETH 286. μP 250 will direct KVM switch 222 to divert KVM signals to KVMoIP module 224 and disconnect local connectors 280, 282, 284, 286, 288 and 290. KVMoIP module 224 will accept the diverted signals and send them to the requesting IT individual's computer running a web browser. This individual will use his local KVM to interact with the remotely managed computer. Commands sent by the requesting IT individual will be received by KVMoIP module 224 and KVMoIP module 224 will then generate proper local electrical signal for the host computer as if there was a conventional KVM attached to the remotely managed computer.

In case there is the need for a shared screen to aid in resolving issues, signals can be sent to μP 250 which will then instruct the KVM switch 222 to split the signals received from connector 212 so that they are split, i.e., coupled to both the connectors and to KVMoIP module 224 and thence to the remote IT individual via ETH 286.

In event that the notebook computer or “target” system is off, a usual state for after hours, and administrators have to perform maintenance on a user's computer, signals will be sent to μP 250 to first power on this notebook computer utilizing power management module 228. Remote access and control then proceeds as described above.

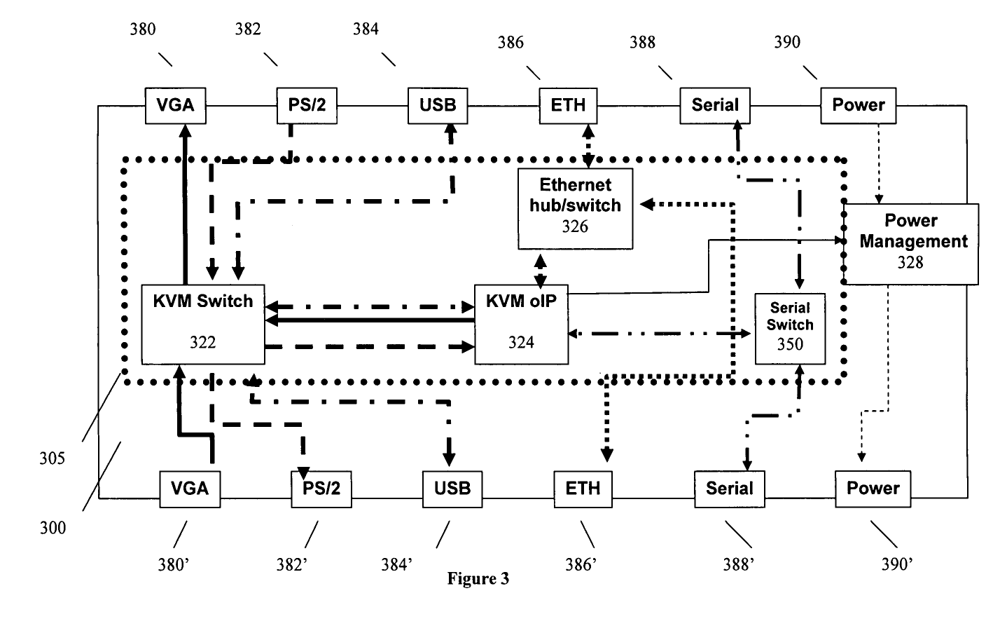

Referring now to FIG. 3, there is shown a baseboard 300 having a module 305 in accordance with another embodiment of the present invention. Instead of connector 212 in FIG. 2, baseboard 300 has dual component connector ports 380-390 and 380′-390′ respectively for VGA, PS/2, USB, Ethernet, serial and power connectivity. Power management module 328 is connected to power ports 390 and 390′.

Module 305 includes a KVM switch 322, KVMoIP module 324, an Ethernet hub/switch 326, and a serial switch 350. KVM switch 322 is connected to VGA ports 380 and 380′, PS/2 ports 382 and 382′, USB ports 384 and 384′, and KVMoIP module 324. KVMoIP module 324 is further connected to power management 328, serial switch 350 and Ethernet hub/switch 326, which is, in turn, further connected to Ethernet ports 384 and 384′. Power management module 328 is connected to power ports 390 and 390′. In addition, serial switch 350 is connected to serial ports 388 and 388′ for coupling serial, e.g., RS232, signals. Although not shown in FIG. 3, a microprocessor could be used and connected in this embodiment as shown and described in reference to FIG. 2.

As stated above, KVMoIP 324 can couple signals via an IPMI bus, and Ethernet hub/switch 326 can be used in any of a number of LAN topologies. Further, the accompanying switches and microprocessor may be compliant with standards for OPMA and/or IPMI.

Although the embodiments illustrated above show the module embedded in a baseboard or equivalent structure, the module could be implemented as a dongle, hardware key, hardware token or equivalent structure for connecting to docking stations, desktops, servers, notebooks, docking stations, personal digital assistants, and next generation phones to provide remote access and control without relying on the operating system or the operational state of the connected to device.

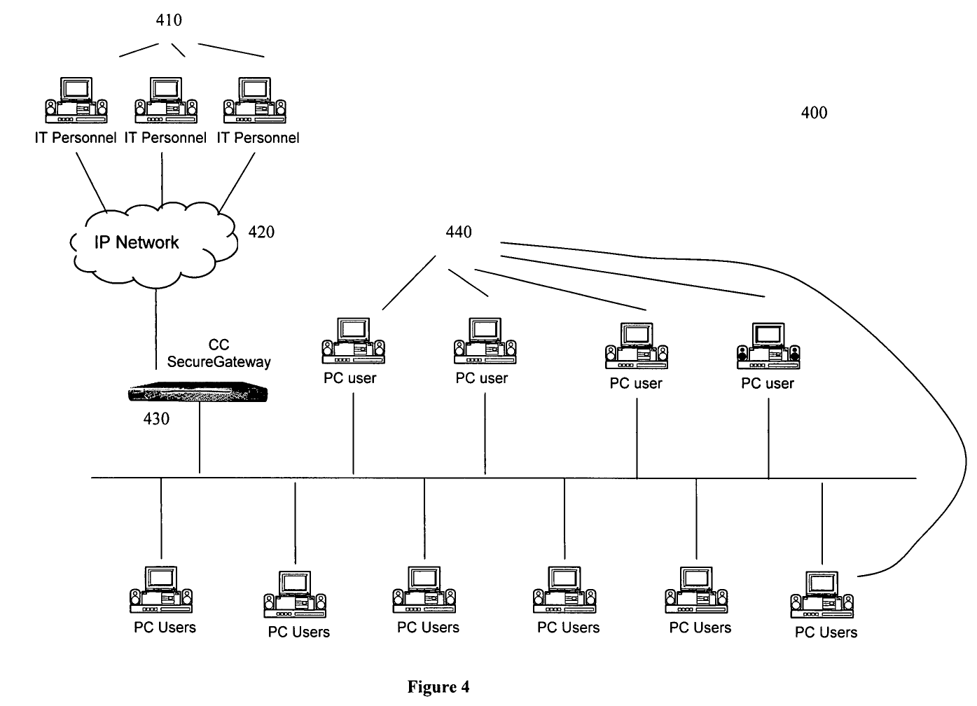

Referring now to FIG. 4, there is shown an exemplary system 400 for using a module in accordance with the invention and as described above. Information technology (IT) personnel 410 are connected via an Internet Protocol (IP) network 420 to a management system 430, such as that provided by Raritan Computer, Inc. and marketed as Raritan's CommandCenter Secure Gateway or an equivalent. Management system 430 is connected to devices 440 equipped with modules according to the invention and consolidates management of devices 440 equipped with the module. The modules, working together with management system 430, permit each of IT personnel 410 to get full control and access to any of devices 440 in system 400. For example, the module permits the IT personnel to power the devices 440 at any time independent of the state of device 440, handle software issues, operational problems and hardware problems. Utilization of the modules will enhance security, permit off peak hour maintenance, reduce downtime, and require no end user involvement. Although the term “connect or connected to” is used in this description, it is meant to include any type of communications, communication links or communication media between the various components.

While the foregoing description and drawings represent the preferred embodiments of the present invention, it will be understood that various changes and modifications may be made without departing from the spirit and scope of the present invention.

What is claimed is:

1. A docking station, comprising:
a module; and
the module including a keyboard, video and mouse (KVM) switch, a KVM over Internet Protocol (KVMoIP) module, and an Ethernet switch, wherein the KVMoIP module is connected to the KVM switch and the Ethernet switch.

2. The docking station of claim 1, wherein the module further includes a serial switch in connection with the KVMoIP module.

3. The docking station of claim 2, wherein the module further includes a microprocessor in connection with the KVM switch, the KVMoIP module, and the Ethernet switch.

4. The docking station of claim 3, further comprising a power management controller, the microprocessor in connection with the power management controller.

5. The docking station of claim 2, further comprising a power management controller, the KVMoIP module in connection with the power management controller.

6. The docking station of claim 4, wherein the KVM switch is in connection with at least one video graphics array (VGA) port, at least one PS/2 port and at least one Universal Serial Bus (USB) port.

7. The docking station of claim 6, wherein the Ethernet switch is in connection with at least one Ethernet port.

8. The docking station of claim 7, wherein the serial switch is in connection with at least one serial port.

9. The docking station of claim 8, wherein the power management controller is in connection with at least one power port.

10. The docking station of claim 1, wherein:
the docking station uses local keyboard, video (monitor) and mouse signals in a conventional mode, and;
the docking station redirects keyboard, video and mouse signals to a remote management system in a maintenance mode.

11. The docking station of claim 9, wherein:
the docking station uses local keyboard, video (monitor) and mouse signals in a conventional mode, and;
the docking station redirects keyboard, video and mouse signals to a remote management system in a maintenance mode.

12. A dongle, comprising:
a keyboard, video and mouse (KVM) switch,
a KVM over Internet Protocol (KVMoIP) module, and
an Ethernet switch,
a serial switch
wherein the KVMoIP module is connected to the KVM switch, the Ethernet switch and the serial switch.

13. The dongle of claim 12, further including a microprocessor in connection with the KVM switch, the KVMoIP module, and the Ethernet switch.

14. The dongle of claim 13, further comprising a power management controller, the microprocessor in connection with the power management controller.

15. The dongle of claim 12, further comprising a power management controller, the KVMoIP module in connection with the power management controller.

16. The dongle of claim 14, wherein
the KVM switch is in connection with at least one video graphics array (VGA) port, at least one PS/2 port and at least one Universal Serial Bus (USB) port;
the Ethernet switch is in connection with at least one Ethernet port;
the serial switch is in connection with at least one serial port; and
the power management controller is in connection with at least one power port.

17. The docking station of claim 9, wherein the dongle provides use of local keyboard, video (monitor) and mouse signals in a conventional mode, and redirects keyboard, video and mouse signals to a remote management system in a maintenance mode.

18. A integrated circuit, comprising:
a keyboard, video and mouse (KVM) switch,
a KVM over Internet Protocol (KVMoIP) module, and
an Ethernet switch,
a serial switch
wherein the KVMoIP module is connected to the KVM switch, the Ethernet switch and the serial switch.

19. The integrated circuit of claim 18, further including a microprocessor in connection with the KVM switch, the KVMoIP module, and the Ethernet switch.

20. The integrated circuit of claim 19, further comprising a power management controller, the microprocessor in connection with the power management controller.

21. The integrated circuit of claim 18, further comprising a power management controller, the KVMoIP module in connection with the power management controller.

22. The integrated circuit of claim 20, wherein
the KVM switch is in connection with at least one video graphics array (VGA) port, at least one PS/2 port and at least one Universal Serial Bus (USB) port;
the Ethernet switch is in connection with at least one Ethernet port;
the serial switch is in connection with at least one serial port; and
the power management controller is in connection with at least one power port.

23. The integrated circuit of claim 20, wherein the integrated circuit provides use of local keyboard, video (monitor) and mouse signals in a conventional mode, and redirects keyboard, video and mouse signals to a remote management system in a maintenance mode.

24. A device, comprising:
a module;
the module including at least three components in connection with each other, the at least three components including a keyboard, video and mouse (KVM) switch, a KVM over Internet Protocol (KVMoIP) module, and an Ethernet switch.

25. The device of claim 24, wherein the module further includes a microprocessor in connection with each of the at least three components.

26. The device of claim 1, wherein the module further includes a serial switch in connection with the KVMoIP module.

27. The device of claim 1, further comprising a power management controller, the KVMoIP module in connection with the power management controller.

28. The device of claim 2, further comprising a power management controller, the microprocessor in connection with the power management controller.

29. The device of claim 1, wherein the KVM switch is in connection with at least one video graphics array (VGA) port, at least one PS/2 port and at least one Universal Serial Bus (USB) port.

30. The device of claim 1, wherein the Ethernet switch is in connection with at least one Ethernet port.

31. The device of claim 3, wherein the serial switch is in connection with at least one serial port.

32. The device of claim 4, wherein the power management controller is in connection with at least one power port.

33. The device of claim 5, wherein the power management controller is in connection with at least one power port.

34. The device of claim 1, wherein the device is a dongle.

35. The device of claim 1, wherein the device is a circuit board.

36. The device of claim 1, wherein the device is at least one from the group of notebook computers, laptop computers, phones, docking stations, servers, desktops, and personal digital assistants.

37. The device of claim 1, wherein:
the device uses local keyboard, video (monitor) and mouse signals in a conventional mode, and;
the device redirects keyboard, video and mouse signals to a remote management system in a maintenance mode.

38. A management module, comprising:
a keyboard, video and mouse (KVM) switch;
a KVM over Internet Protocol (KVMoIP) module; and
an Ethernet switch,
wherein the KVM switch, the KVMoIP and the Ethernet switch are connected to each other.

39. The management module of claim 38, wherein the management module further includes a microprocessor in connection with the KVM switch, the KVMoIP module and the Ethernet switch.

40. The management module of claim 38, wherein the management module further includes a serial switch in connection with the KVMoIP module.

41. The management module of claim 38, wherein the management module is embedded in a circuit board.

42. The management module of claim 38, wherein the management module is implemented as a dongle.

43. The management module of claim 41, wherein the circuit board further comprises:
a power management controller, the KVMoIP module in connection with the power management controller.

44. The management module of claim 41, further comprising a microprocessor and wherein the circuit board further comprises a power management controller, the microprocessor in connection with the power management controller.

45. The management module of claim 41, wherein the circuit board further comprises:
at least one video graphics array (VGA) port;
at least one PS/2 port;
at least one Universal Serial Bus (USB) port; and
at least one Ethernet port,
wherein the KVM switch is in connection with the at least one video graphics array (VGA) port, the at least one PS/2 port and the at least one Universal Serial Bus (USB) port, and
the Ethernet switch is connected to the least one Ethernet port.

46. The management module of claim 40, wherein the management module is embedded in a circuit board and wherein the serial switch is in connection with at least one serial port in the circuit board.
